(19) United States
(12) Patent Application Publication
(10) Pub. No.: US 2026/0242607 A1
(43) Pub. Date: Aug. 20, 2026

(54) Fast Dispersing Pigment Brown 29

(71) Applicant: Sun Chemical B.V., Weesp (NL)

(72) Inventors: David BÖHNISCH, Besigheim (DE); Aron WOSYLUS, Besigheim (DE); Christian FISCHER, Besigheim (DE); Joachim FELLER, Besigheim (DE)

(73) Assignee: Sun Chemical B.V., Weesp (NL)

(21) Appl. No.: 19/482,724

(22) PCT Filed: Sep. 21, 2023
(86) PCT No.: PCT/EP2023/076075

§ 371 Date: Nov. 7, 2025

(30) Foreign Application Priority Data
Sep. 22, 2022 (EP) 22197251.6

(51) Int. Cl. C09B 67/22; C01G 49/02; C09C 1/34; C09D 1/00

(52) U.S. Cl. CPC C09B 67/0034; C01G 49/02; C09C 1/34; C09D 1/00

(57) ABSTRACT

A chromium and iron oxide-based pigment with Pigment Brown 29 as a color index which was dry milled and can be fast dispersed in different solvent and water-based coatings.

Ink and coating formulations are typically prepared by dispersing pigment powder in a solvent or water-based binder system. Examples of dispersing equipment includes ball mills, bead mills, rotor-stator disperses, 3-rolls, impeller mills or shaking machine. The powder dispersing process is a very time and energy consuming pursuit, usually requiring a number of hours to achieve the desired level of dispersion. During the dispersing procedure, the pigment goes through a series of complex, interlinked processes. A wetting process occur where adsorbed air is removed from the particle surface while a solvate layer is formed.

Before, during and after the wetting process deagglomeration takes place. External energy is required in the dispersion process to the system to break up the pigment agglomerates and to achieve a uniform particle distribution throughout the binder system. Subsequently, the deagglomerated particles need to be stabilized to prevent flocculation. This can be achieved by applying repulsive forces, i.e., electrostatic, or steric, between single particles.

Normally, inorganic pigment powders are produced via solid-state reactions, co-grinding reactions, or precipitation reactions. Typically, a heat treatment process is applied at least once during the production of an inorganic pigment. This heat treatment can be realized, for example, in a muffle furnace, rotary kiln, microwave furnace, vertical furnace, or electric arc furnace. This heat treatment generates agglomerates of pigment particles which need to be broken up during the dispersing process. Thus, a milling process is usually required during the manufacture of a printing ink, paint or coating. Milling may be achieved, for example, by ball mills, hammer mills, jet mills, bead mills or pen mills. In a wet milling process, energy is applied to the pigment particles resulting in de-agglomeration and higher color strength. However, when a wet milling process is used, a drying process is subsequently needed, resulting in the generation of new agglomerates, which must be broken up again during the dispersion process and leads to high processing times. Hence, it is important to use a dry milling technique, i.e., jet mills, hammer mills, dry ball mills or pen mills, to eliminate the need for a subsequent drying process.

Some properties of the coating system depend on the degree of dispersing, i.e., color strength or tinting strength, color hue, hiding power, viscosity, gloss, and fineness of grind. In addition, some properties, e.g., color strength, depend so strongly on the degree of dispersing that it can be used to directly determine the degree of dispersibility. Thus, when color strength is continuously increasing, even after long dispersing times, the dispersibility is still rather low. Conversely, when the increase in color strength approaches or reaches its maximum, the dispersibility is considered high.

In addition, when the pigment is used in thin coatings the final pigment should exhibit low fineness of grind values to ensure that no larger particles or agglomerates create poor printability, e.g. a rough surface on top of the applied coating.

The cited references do not refer to the targeted properties (lightness value, color strength, fineness of grind, dispersibility index). Furthermore, the references do not refer to the use of dry milling technique to enhance the dispersibility of the obtained pigment.

All of the references that refer to an improvement of the dispersibility use further additives like surface modifiers or polymer composites or resins. Furthermore, references that describe an easy dispersible property combine this property with a wet to semi-dry pigment. To achieve a final easy dispersible pigment in powder form, an additional energy and time-consuming drying step would be necessary. Nevertheless, an additional drying step would lead to agglomeration and would negate the easy dispersible property.

Generally, the color of an (Fe,Cr)₂O₃-based pigment is depending on its particle size as well as its chromium content. When the particle size Dv(50) is in the range of a few hundred nanometers, the pigment exhibits a brown color. However, when the particle size Dv(50) is increased to roughly 1 μm, the pigment becomes black.

U.S. Pat. No. 4,643,772A discloses a process for a brown (Fe,Cr)₂O₃-based pigment, wherein a transparent alpha iron oxide having an orthorhombic bipyramidal crystal structure with Dv(50) in the range between 0.1 and 0.4 μm and a chromium salt are used as a starting material to achieve the brown color as well as the readily dispersible property. The process is a precipitation process in which a chromium salt is dissolved and precipitated as chromium hydroxide in the presence of iron oxide with an alkali carbonate. Afterwards, the precipitate is filtered off, dried and calcined. After the calcination, the product is wet milled in a ball mill, sand mill or bead mill. Thereafter, the product is filtered and the pigment slurry is dried again. Due to the small particle size of the repeatedly milled pigments, the obtained pigments of U.S. Pat. No. 4,643,772A show a better dispersibility. However, to achieve a black color of a (Fe,Cr)₂O₃-based pigment with particle sizes (Dv(50)) of more than 1 μm having a good dispersibility is still difficult.

GB1530740A discloses a process in which an Fe₂O₃-based pigment is obtained using ferrous sulphate as an iron source which is an effluent from the processing cycle of TiO₂. Moreover, different modifying elements to adjust the color of the final pigment are used. When chromium is used as a modifying element, a rather brown pigment is obtained. The Fe₂O₃-based pigment is obtained by a wet mixing process where all starting materials are dissolved. After calcination, the received pigment is not milled, so that the pigment will be coarse and not readily dispersible due to many agglomerates, which need to be broken up during the dispersing process, which is time and energy consuming. The pigments of the present invention are obtained by dry mixing the starting components to skip an additional drying step before the calcination process. Additionally, solely iron and chromium elements are used in the pigments of the present invention to obtain a black pigment, without the addition of any modifying elements as required in GB1530740A.

Investigation showed that dry milled pigments show only a slight increase in color strength over time as well as low fineness of grind values, thus providing pigments with high dispersibility. We found that by adjusting the milling parameters we can increase the dispersibility of the pigment and simultaneously while either not changing the color properties or even improving them.

The present invention addresses the high energy and time-consuming shortcoming by providing a specific pigment that can be dispersed with reduced time and energy requirements. The inventive and eco-friendly pigment as supplied imparts similar or even superior performance properties to commercially available pigments with the advantages of faster processing time and reduced energy expenditure. In one embodiment, the inventive pigment exhibits increased color strength and therefore the possibility of using a lower amount of pigment.

Citation or identification of any document in this application is not an admission that such represents prior art to the present invention.

### BRIEF DESCRIPTION OF THE DRAWINGS

FIG. 1—Depicts four different particle size distributions. These were measured using water as a dispersing medium. Before and during measurement no ultrasonic was applied. The particle size distributions of the described invention are shown as squares. The distributions are measured after 1 min, 3 min and 5 min dispersing. The commercially available Pigment Brown 29 Sicopal Black 0095 is shown as triangles after 5 min dispersing. While the particle size distributions of the invention show monomodal gaussian curves, Sicopal Black 0095 exhibits a bimodal gaussian curve. Moreover, it exhibits larger particles, since the curve bottoms out at larger particle sizes resulting in a higher Dv(100) of 9.2 μm and a higher fineness of grind value in a coating system as defined herein. The inventive pigment shows a more distinct particle size distribution due to its monomodal gaussian curve. In addition, the distribution does not change over time underlining the fact that the pigment is already fully dispersed in water after 1 min. Furthermore, the curve bottoms out at a smaller particle size resulting in a Dv(100) of 6 μm and a lower fineness of grind value in a coating system.

### DETAILED DESCRIPTION

In the present invention, a chromium and iron-based oxide with a pigment index of Pigment Brown 29 with a Hematite crystal structure is synthesized through a solid-state reaction between a chromium source, for example one or more of chromium oxide, chromium hydroxide, chromium oxalate, chromium carbonate, chromium sulfate, chromium chloride, chromium bromide, chromium iodide, chromium nitrate, chromic acid, chromium chromate, chromium thiocyanide, chromium cyanide; and an iron source, for example one or more of iron oxide, iron hydroxide, iron oxalate, iron carbonate, iron sulfate, iron chloride, iron bromide, iron iodide, iron nitrate, iron thiocyanide, iron cyanide. The raw materials are mixed in a weight ratio related to the chromium content of 1:99 to 50:50; 10:90 to 30:70; or 25:75 to 42:58. In one embodiment, the composition can further include other transition metal compounds of period 4 elements or rare earth metals from the group of oxides, hydroxides, oxalates, carbonates, sulfates, chlorides, bromides, iodides, nitrates, or thiocyanides. In a further embodiment, the other transition metal or rare earth compound would be present at 0-10 wt % of the total composition, or 0-5 wt %.

The mixture is then calcined at elevated temperatures for example in a muffle furnace, rotary kiln, microwave furnace, vertical furnace, or electric arc furnace. The temperature varies and is set to different temperatures during the heat treatment. In in one embodiment, the temperature ranges from 500 to 1300° C., preferably the temperature ranges from 550 to 1250° C., more preferably the temperature ranges from 610 to 1170° C. After heat treatment, the accrued pigment is pre-ground for example on a hammermill or on a crusher (i.e., roll crusher, jaw crusher, gyratory crusher, impact crusher or cone crusher). The pre-ground step can optionally be omitted when the calcined pigment does not show any chunks or big agglomerates. Grinding aids like fumed silica and alkaline earth carbonates are then optionally added to the accrued pigment for example in a proportion of 0-10% by weight, or 0-5% by weight. The resulting mixture is then dry milled for example on a jet mill, hammer mill, dry ball mill or pen mill. In a specific embodiment the pigment of the present invention would be milled by a jet mill, which facilitates adjustment of the particle size distribution in the final product. During the milling process the particle size distribution as well as the fineness of grind are reduced. In one embodiment the particle size should be Dv(100)≤10 μm and the fineness of grind ≤15 μm.

Due to the reduction, or more preferably elimination, of agglomerates, the present invention shows reduced time and energy consumption when it is dispersed in a binder system. The system can be for example any solvent, water-based or energy curable system. Since no agglomerates are present, less external energy needs to be applied to disperse the pigment. Thus, the wetting process can initially take place and reduces the time needed. In addition, no additional milling step during dispersing is needed. The dispersing process can be conducted using less complex dispersing tools, for example a dissolver. Since no reprocessing step is needed, i.e., separating balls from the coating system, time consumption is further reduced. Due to its high dispersibility, the color strength reaches its maximum after only a short duration of dispersing. Furthermore, since it is possible to fully disperse the pigment in some coating systems, it shows an increased color strength compared to other commercially available pigments. Although during the dry milling step agglomerates are broken up, main particles or aggregates stays intact and thus, the color properties, i.e., color hue, chroma, hiding power, gloss, lightness value, remain constant and show similar properties to commercially available pigments. Color properties are dependent upon the coating system.

Method for determining Dispersibility Index (DI) of Pigment Brown 29 using Equation 1:

$$DI = \frac{{10}^{3} \cdot Color Strength}{{FOG}^{2} ( μm ) \cdot Lightness Value \cdot Dv ( 100 ) ( μm )} . \qquad ( Equation 1 )$$

Equation 1 can be used to derive the Dispersibility Index (DI) for the Inventive Example 1 Pigment Brown 29 versus the Comparative Example 1, which represents the commercially available Pigment Brown 29 (Pigment Brown 29, Sicopal Black 0095, BASF, purchased in 2022) dispersed in various binder systems, with a higher DI value being indicative of easier dispersibility and higher blackness. The pigments of Comparative Examples 2 and 3, represents the commercially available Dynamix Black pigments (Dynamix Black 30C941 and Dynamix Black 30C940, Shepherd, purchased in 2023) are not used for determining the Dispersibility Index (DI) according to the present invention. According to the present invention, FOG represents fineness of grind.

In one embodiment, the binder system comprising the Example 1 pigment would exhibit a Dispersibility Index (DI) increase of ≥100%, or ≥200%, or ≥250% vs. a comparative example after being subjected to 30 min using a dissolver dispersion process in a melamine-based solvent borne binder system or a water-based binder system, and wherein DI is determined according to Equation 1.

In another embodiment, the binder system comprising the Example 1 pigment would exhibit a Dispersibility Index (DI) increase of ≥1000%, or ≥2000%, or ≥2500% vs. a comparative example after being subjected to 30 min using a dissolver dispersion process in a melamine-based solvent borne binder system or a water-based binder system, and wherein DI is determined according to Equation 1.

In another embodiment, the binder system comprising the Example 1 pigment would exhibit a Dispersibility Index (DI) increase of ≥500%, or ≥600%, or ≥700%, or ≥800%, or ≥900% vs. a comparative example after being subjected to 30 min using a dissolver dispersion process in a two-component polyurethane solvent borne binder system, and wherein DI is determined according to Equation 1.

In another embodiment, the binder system comprising the Example 1 pigment would exhibit a Dispersibility Index (DI) increase of ≥1000%, or ≥2000%, or ≥2500% vs. a comparative example after being subjected to 30 min using a dissolver dispersion process in a Polyvinylidene fluoride (PVDF) resin-based binder system, and wherein DI is determined according to Equation 1.

The present invention further relates to a Pigment Brown 29 pigment composition, comprising chromium and an iron-based oxide with a hematite structure, wherein the pigment exhibits a Dispersibility Index (DI) increase of ≥1000%, or ≥2000%, or ≥2500% vs. a comparative example after being subjected to 30 minutes using a dissolver dispersion process in a melamine-based solvent borne binder system or a water-based binder system, and wherein DI is determined according to Equation 1:

$$DI = \frac{{10}^{3} \cdot Color Strength}{{FOG}^{2} ( μm ) \cdot Lightness Value \cdot Dv ( 100 ) ( μm )} . \qquad ( Equation 1 )$$

Since Pigment Brown 29 is described as very dark brown, almost black pigment, only the lightness value is needed to describe its color properties. In the CIELAB color space the a and b values reflect the four unique colors of human vision: red, green, blue, and yellow. Thus, for a very dark brown or black pigment, the a and b values are close to zero and superfluous. However, the lightness value immediately indicates if a pigment is white or black. It defines black at 0 and white at 100. Hence, the lightness value for a black should be as close to zero as possible. In addition, color strength, fineness of grind and the Dv(100) of the particle size distribution are used in order to define the dispersibility of the pigment. If a pigment has a higher color strength than a comparable pigment, this is equivalent to better dispersibility. Similar for the fineness of grind. If agglomerates or coarse particles of a pigment deagglomerate faster than a comparable pigment, this is equivalent to better dispersibility. Since color strength and fineness of grind are dependent on a used coating system, the Dv(100) is independent of any coating system. The Dv(100) describes the biggest particle or agglomerate in a pigment. If the Dv(100) is already small, no agglomerates or coarse particle have to be deagglomerate and thus reduced dispersion time is necessary. Equation 1 contains all described parameters to achieve an index, which rates the dispersibility of a pigment brown 29. The higher the value the better the dispersibility and blackness. This index can be used to compare the dispersibility and applicability of different pigment brown 29 compounds.

The invention is further described by the following numbered paragraphs:
1. A Pigment Brown 29 pigment composition, comprising chromium and an iron-based oxide with a hematite structure, wherein the pigment exhibits a Dispersibility Index (DI) increase of ≥100%, or ≥200%, or ≥250% vs. a comparative example after being subjected to 30 minutes using a dissolver dispersion process in a melamine-based solvent borne binder system or a water-based binder system, and wherein DI is determined according to Equation 1:

$$DI = \frac{{10}^{3} \cdot Color Strength}{{FOG}^{2} ( μm ) \cdot Lightness Value \cdot Dv ( 100 ) ( μm )} . \qquad ( Equation 1 )$$

2. The pigment composition of paragraph 1, wherein the color strength in the melamine-based solvent borne binder system is in the range of from 105 to 155, preferably in the range of from 115 to 145, more preferably in the range of from 125 to 135.
3. The pigment composition paragraph 1, wherein the FOG in the melamine-based solvent borne binder system is in the range of from 5 to 20 μm, preferably in the range of from 6 to 15 μm, more preferably in the range of from 7 to 10 μm.
4. The pigment composition of paragraph 1, wherein the lightness value in the melamine-based solvent borne binder system is in the range of from 6 to 25, preferably in the range of from 7 to 18, more preferably in the range of from 8 to 12.5.
5. The pigment composition of paragraph 1, wherein the color strength in the water-based binder system is in the range of from 90 to 120, preferably in the range of from 95 to 115, more preferably in the range of from 100 to 110.
6. The pigment composition paragraph 1, wherein the FOG in the water-based binder system is in the range of from 5 to 25 μm, preferably in the range of from 8 to 20 μm, more preferably in the range of from 11 to 15 μm.
7. The pigment composition of paragraph 1, wherein the lightness value in the water-based binder system is in the range of from 3 to 12, preferably in the range of from 4 to 10, more preferably in the range of from 5 to 8.
8. A Pigment Brown 29 pigment composition, comprising chromium and an iron-based oxide with a hematite structure, wherein the pigment exhibits a Dispersibility Index (DI) increase of ≥500%, or ≥600%, or ≥700%, or ≥800%, or ≥900% vs. a comparative example after being subjected to 30 minutes using a dissolver dispersion process in a two-component polyurethane solvent borne binder system, and wherein DI is determined according to Equation 1:

$$DI = \frac{{10}^{3} \cdot Color Strength}{{FOG}^{2} ( μm ) \cdot Lightness Value \cdot Dv ( 100 ) ( μm )} . \qquad ( Equation 1 )$$

9. The pigment composition of paragraph 8, wherein the color strength is in the range of from 100 to 130, preferably in the range of from 105 to 125, more preferably in the range of from 110 to 120.
10. The pigment composition of paragraph 8, wherein the FOG is in the range of from 5 to 20 μm, preferably in the range of from 6 to 15 μm, more preferably in the range of from 7 to 10 μm.
11. The pigment composition of paragraph 8, wherein the lightness value is in the range of from 6 to 25, preferably in the range of from 7 to 18, more preferably in the range of from 8 to 11.
12. A Pigment Brown 29 pigment composition, comprising chromium and an iron-based oxide with a hematite structure, wherein the pigment exhibits a Dispersibility Index (DI) increase of ≥1000%, or ≥2000%, or ≥2500% vs. a comparative example after being subjected to 30 minutes using a dissolver dispersion process in a Polyvinylidene fluoride (PVDF) resin-based binder system, wherein DI is determined according to Equation 1:

$$DI = \frac{{10}^{3} \cdot Color Strength}{{FOG}^{2} ( μm ) \cdot Lightness Value \cdot Dv ( 100 ) ( μm )} . \qquad ( Equation 1 )$$

13. The pigment composition of paragraph 12, wherein the color strength is in the range of from 100 to 130, preferably in the range of from 105 to 125, more preferably in the range of from 110 to 120.
14. The pigment composition paragraph 12, wherein the FOG is in the range of from 2 to 15 μm, preferably in the range of from 3 to 10 μm, more preferably in the range of from 4 to 5 μm.
15. The pigment composition of paragraph 12, wherein the lightness value is in the range of from 6 to 25, preferably in the range of from 7 to 18, more preferably in the range of from 8 to 11.
16. The pigment composition of any preceding paragraph, wherein the comparative example is a commercially available Pigment Brown 29 as described herein.
17. The pigment composition of any preceding paragraph, wherein the Dv(100) is in the range of from 3 to 9 μm, preferably in the range of from 5 to 8, more preferably in the range of from 5.5 to 7.5 μm, more preferably in the range of from 6 to 7 μm.
18. The pigment composition of any preceding paragraph, wherein the chromium is selected from the group consisting of chromium oxide, chromium hydroxide, chromium oxalate, chromium carbonate, chromium sulfate, chromium chloride, chromium bromide, chromium iodide, chromium nitrate, chromic acid, chromium chromate, chromium thiocyanide, chromium cyanide and mixtures thereof, preferably from the group consisting of chromium oxide, chromium hydroxide and a mixture thereof, more preferably the chromium comprises, more preferably is chromium oxide.
19. The pigment composition of any preceding paragraph, wherein the iron-based oxide is selected from the group consisting of iron oxide, iron hydroxide, iron oxalate, iron carbonate, iron sulfate, iron chloride, iron bromide, iron iodide, iron nitrate, iron thiocyanide, iron cyanide and mixtures thereof, preferably from the group consisting of iron oxide, iron hydroxide and a mixture thereof, more preferably the iron-based oxide comprises, more preferably is iron hydroxide.
20. The pigment composition of any of preceding paragraph, wherein from 90 to 100 weight-%, preferably from 95 to 100 weight-%, more preferably from 98 to 100 weight-%, more preferably from 99 to 100 weight-% of the pigment composition comprises a chromium and an iron-based oxide.
21. The pigment composition of any preceding paragraph, further comprising a grinding aid, preferably the grinding aid is selected from the group consisting of an silicon oxide, an alkaline earth metal oxide, an alkaline earth metal carbonate and a mixture thereof, more preferably the grinding aid comprises an alkaline earth metal carbonate, preferably the alkaline earth metal carbonate is selected from the group consisting of magnesium carbonate, calcium carbonate, and a mixture thereof, more preferably the alkaline earth metal carbonate comprises, more preferably is calcium carbonate.
22. The pigment composition of paragraph 21, wherein from 0.1 to 8 weight-%, preferably from 0.2 to 6 weight-%, more preferably from 0.25 to 4 weight-%, more preferably from 0.5 to 2 weight-% of the pigment composition comprises the grinding aid, based on 100 weight-% of the pigment composition.
23. The pigment composition of any preceding paragraph, wherein the pigment composition does not comprise a compound selected from the group consisting of manganese oxide, manganese trioxide, manganite, and a mixture thereof.
24 The pigment composition of any preceding paragraph, with the proviso that a pigment composition comprising a compound selected from the group consisting of manganese oxide, manganese trioxide, manganite, and a mixture thereof is excluded.
25. The pigment composition of any one of paragraphs 1 to 22, further comprising an additional transition metal compound.
26. The composition of paragraph 25, wherein the additional transition metal compound is selected from the group consisting of manganese oxide, manganese trioxide, manganite and mixtures thereof.
27. The pigment composition of any preceding paragraph, wherein the raw materials are mixed in a ratio related to the chromium content of 1:99 to 50:50; 10:90 to 30:70; or 25:75 to 42:58.
28. An ink, paint or coating composition, comprising the pigment of any one or more of paragraphs 1-27.
29. Use of a pigment composition according to any preceding paragraph as a component in an ink, a paint or a coating.
30. A method for preparing one or more of an ink, a paint or a coating, comprising employing a pigment composition according to any preceding paragraph as a component.
31. A process for preparing a Pigment Brown 29 pigment composition, comprising a solid-state reaction between a mixture of a chromium source and an iron source, wherein the mixture is calcined at elevated temperatures and then dry milled, and wherein the pigment exhibits a Dispersibility Index (DI) increase of ≥100%, or ≥200%, or ≥250% vs. a comparative example after being subjected to 30 minutes using a dissolver dispersion process, and wherein DI is determined according to Equation 1:

$$DI = \frac{{10}^{3} \cdot Color Strength}{{FOG}^{2} ( μm ) \cdot Lightness Value \cdot Dv ( 100 ) ( μm )} . \qquad ( Equation 1 )$$

32. The process of paragraph 31, further comprising the step of pre-grinding after being calcined.
33. The process of paragraph 31 or 32, wherein the mixture is calcined at a temperature in the range of from 500 to 1300° C., preferably in the range of from 550 to 1250° C., more preferably in the range of from 610 to 1170° C.
34. The process of any one or more of paragraphs 31-33, wherein the mixture is calcined in a rotary device at a rotary speed in the range of from 0.2 to 10 rpm, preferably in the range of from 1 to 5 rpm.
35. The process of any one or more of paragraphs 31-34, wherein the mixture is dry milled in a jet mill, preferably in a fluidized bed counterjet mill at a pressure in the range of from 0.5 to 5 bar, preferably in the range of from 1.5 to 3 bar and at a classifier wheel speed in the range of from 3000 to 7000 rpm, preferably in the range of from 3500 to 6500 rpm, more preferably in the range of from 4000 to 6000 rpm.
36. The process of any one or more of paragraphs 31-35, wherein the chromium source and the iron source are mixed at an iron source:chromium source ratio in the range of from 74:26 to 58:42, preferably at an iron source:chromium source ratio in the range of from 70:30 to 58:42, more preferably at an iron source:chromium source ratio of 67:33.
37. The process of any one or more of paragraphs 31-36, wherein the raw materials are mixed in a ratio related to the chromium content of 1:99 to 50:50; 10:90 to 30:70; or 25:75 to 42:58.
38. The process of any one or more of paragraphs 31-37, wherein the composition further comprises a further transition metal compound.
39. The process of paragraph 38, wherein the further transition metal compound does not comprise manganese, preferably the further transition metal compound does not comprise manganese oxide, manganese trioxide, and manganite.
40. The process of paragraph 38, wherein the further transition metal compound is selected from the group consisting of manganese oxide, manganese trioxide, manganite or mixtures thereof.
41 The process of any one or more of paragraphs 31-40, wherein the iron-based oxide is selected from the group consisting of iron oxide, iron hydroxide, iron oxalate, iron carbonate, iron sulfate, iron chloride, iron bromide, iron iodide, iron nitrate, iron thiocyanide, iron cyanide and mixtures thereof, preferably from the group consisting of iron oxide, iron hydroxide and a mixture thereof, more preferably the iron-based oxide comprises, more preferably is iron hydroxide.
42. The process of any one or more of paragraphs 31-41, wherein the chromium is selected from the group consisting of chromium oxide, chromium hydroxide, chromium oxalate, chromium carbonate, chromium sulfate, chromium chloride, chromium bromide, chromium iodide, chromium nitrate, chromic acid, chromium chromate, chromium thiocyanide, chromium cyanide and mixtures thereof, preferably from the group consisting of chromium oxide, chromium hydroxide and a mixture thereof, more preferably the chromium comprises, more preferably is chromium oxide.
43. The process of any one or more of paragraphs 31-42, further comprising one or more grinding aids.
44. The process of paragraph 43, wherein the grinding aid is selected from the group consisting of a fumed silica, an alkaline earth metal oxide, an alkaline earth metal carbonates and mixtures thereof, preferably the grinding aid is selected from the group consisting of a fumed silica, an alkaline earth metal oxide, an alkaline earth metal carbonate and a mixture thereof, more preferably the grinding aid comprises an alkaline earth metal carbonate, preferably the alkaline earth metal carbonate is selected from the group consisting of magnesium carbonate, calcium carbonate, and a mixture thereof, more preferably the alkaline earth metal carbonate comprises, more preferably is calcium carbonate.
45. The process of paragraph 43 or 44, wherein the grinding aid is added in an amount of from 0.1 to 8 weight-%, preferably from 0.2 to 6 weight-%, more preferably from 0.25 to 4 weight-%, more preferably from 0.5 to 2 weight-%, based on 100 weight-% of the calcined mixture.
46. The process of any one or more of paragraphs 31-45, wherein the particle size is Dv(100)≤10 μm and the fineness of grind is ≤15 μm when incorporated into an ink, paint or coating system.
47. The process of any one or more of paragraphs 31-46, wherein ultrasonic is not used.
48. The process of any one or more of paragraphs 31-47 with the proviso that ultrasonic is excluded.
49. A pigment composition, obtainable or obtained by a process according to any one or more of paragraphs 31-48.

Further, the present invention relates to a pigment composition comprising a mixed oxide of Fe(III) and Cr(III), wherein the pigment composition has a lightness value in the range of from 5 to 25, and
wherein the mixed oxide of Fe(III) and Cr(III):
   is according to a chemical formula (Cr,Fe)₂O₃,
   has a hematite structure,
   has a Dv(100) value in the range of from 3 to 9 μm, and
   has a ratio of Fe(III):Cr(III) in the range of from 74:26 to 58:42.

It is preferred that the mixed oxide has a Dv(100) value in the range of from 5 to 8 μm, preferably in the range of from 5.5 to 7.5 μm, more preferably in the range of from 6 to 7 μm.

It is preferred that the mixed oxide has a ratio of Fe(III):Cr(III) in the range of from 70:30 to 58:42, preferably the mixed oxide has a ratio of Fe(III):Cr(III) of 67:33.

It is preferred that the pigment composition has a lightness value in the range of from 3 to 28, preferably in the range of from 4 to 26, more preferably in the range of from 5 to 24.

It is preferred that the lightness value is determined in a melamine-based solvent borne binder system, in a water-based binder system or in a two-component polyurethane solvent borne binder system.

It is preferred that the pigment composition has a color strength (CS):
in the range of from 90 to 120, preferably in the range of from 95 to 115, more preferably in the range of from 100 to 110 in a water-based binder system; or
in the range of from 105 to 155, preferably in the range of from 115 to 145, more preferably in the range of from 125 to 135 in a melamine-based solvent borne binder system; or
in the range of from 100 to 130, preferably in the range of from 105 to 125, more preferably in the range of from 110 to 120 in a two-component polyurethane solvent borne binder system.

It is preferred that the pigment composition has a fineness of grind (FOG):
in the range of from 5-25 μm, preferably in the range of from 8-20 μm, more preferably in the range of from 11-15 μm in a water-based binder system; or
in the range of from 5 to 20 μm, preferably in the range of from 6 to 15 μm, more preferably in the range of from 7 to 10 μm in a melamine-based solvent borne binder system; or
in the range of from 5 to 20 μm, preferably in the range of from 6 to 15 μm, more preferably in the range of from 7 to 10 μm in a two-component polyurethane solvent borne binder system.

It is preferred that the pigment composition does not comprise a compound selected from the group consisting of manganese oxide, manganese trioxide, manganite, and a mixture thereof.

It is preferred that a pigment composition comprising a compound selected from the group consisting of manganese oxide, manganese trioxide, manganite, and a mixture thereof is excluded.

It is preferred that from 90 to 100 weight-%, preferably from 95 to 100 weight-%, more preferably from 98 to 100 weight-%, more preferably from 99 to 100 weight-% of the pigment composition comprises a mixed oxide of Fe(III) and Cr(III).

It is preferred that the pigment composition further comprises a grinding aid, preferably the grinding aid is selected from the group consisting of an oxide of silicon, an alkaline earth metal oxide, an alkaline earth metal carbonate and a mixture thereof, more preferably the grinding aid comprises an alkaline earth metal carbonate, preferably the alkaline earth metal carbonate is selected from the group consisting of magnesium carbonate, calcium carbonate, and a mixture thereof, more preferably the alkaline earth metal carbonate comprises, more preferably is calcium carbonate.

It is preferred that the oxide of silicon is fumed silica.

It is preferred that from 0.1 to 8 weight-%, preferably from 0.2 to 6 weight-%, more preferably from 0.25 to 4 weight-%, more preferably from 0.5 to 2 weight-% of the pigment composition comprises the grinding aid, based on 100 weight-% of the pigment composition.

The present invention also relates to a process for preparing a pigment composition, preferably a pigment composition of any one of the particular and preferred embodiments of the present invention, the process comprising:
(i) providing a Cr(III) source and a Fe(III) source at a Fe(III):Cr(III) ratio in the range of from 74:26 to 58:42;
(ii) calcining the Cr(III) source and the Fe(III) source in a rotary device at a temperature in the range of from 500 to 1300° C. and at a rotary speed in the range of from 0.2 to 10 rpm, and obtaining a calcined mixture;
(iii) providing the calcined mixture and optionally a grinding aid;
(iv) dry milling the calcined mixture and the optional grinding aid in a jet mill at a pressure in the range of from 0.5 to 5 bar and at a classifier wheel speed in the range of from 3000 to 7000 rpm;
(v) obtaining a pigment composition comprising a mixed oxide of Fe(III) and Cr(III), wherein the pigment composition has a lightness value in the range of from 5 to 25.

It is preferred that prior to (iv), the process further comprises
(iii.1) grinding the provided calcined mixture and the optional grinding aid.

It is preferred that wherein in (i), the Cr(III) source and the Fe(III) source is provided at a Fe(III):Cr(III) ratio in the range of from 70:30 to 58:42, preferably the Cr(III) source and the Fe(III) source are provided at a Fe(III):Cr(III) ratio of 67:33.

It is preferred that wherein the Fe(III) source is selected from the group consisting of iron oxide, iron hydroxide, iron oxalate, iron carbonate, iron sulfate, iron chloride, iron bromide, iron iodide, iron nitrate, iron thiocyanide, iron cyanide and a mixture thereof, preferably from the group consisting of iron oxide, iron hydroxide and a mixture thereof, more preferably the iron (III) source comprises, more preferably is iron hydroxide.

It is preferred that the Cr(III) source is selected from the group consisting of chromium oxide, chromium hydroxide, chromium oxalate, chromium carbonate, chromium sulfate, chromium chloride, chromium bromide, chromium iodide, chromium nitrate, chromic acid, chromium chromate, chromium thiocyanide, chromium cyanide and a mixture thereof, preferably from the group consisting of chromium oxide, chromium hydroxide and a mixture thereof, more preferably the Cr(III) source comprises, more preferably is chromium oxide.

It is preferred that in (ii), from 0.1 to 8 weight-%, preferably from 0.2 to 6 weight-%, more preferably from 0.25 to 4 weight-%, more preferably from 0.5 to 2 weight-% of the grinding aid, based on 100 weight-% of the calcined mixture, is added.

It is preferred that in the grinding aid is selected from the group consisting of a fumed silica, an alkaline earth metal oxide, an alkaline earth metal carbonate and a mixture thereof, more preferably the grinding aid comprises an alkaline earth metal carbonate, preferably the alkaline earth metal carbonate is selected from the group consisting of magnesium carbonate, calcium carbonate, and a mixture thereof, more preferably the alkaline earth metal carbonate comprises, more preferably is calcium carbonate.

It is preferred that in (ii), the Cr(III) source and the Fe(III) source is calcined at a temperature in the range of from 500 to 1300° C., preferably in the range of from 550 to 1250, more preferably in the range of from 610 to 1170° C.

It is preferred that in (ii), the rotary speed is in the range of from 1 to 5 rpm.

It is preferred that in (iv), the jet mill is a fluidized bed counterjet mill.

It is preferred that in (iv), the dry milling is at a classifier wheel speed in the range of from 4500 to 6000 rpm.

It is preferred that in (v), the pigment composition has a lightness value in the range of from 3 to 28, preferably in the range of from 4 to 26, more preferably in the range of from 5 to 24.

It is preferred that in (v), the lightness value is determined in a melamine-based solvent borne binder system, in a water-based binder system or in a two-component polyurethane solvent borne binder system.

It is preferred that ultrasonic is not used.

The present invention also relates to a pigment composition, obtainable or obtained by a process of any one of the particular and preferred embodiments of the present invention.

The present invention also relates to an ink, a paint or a coating, comprising or consisting of a pigment composition of any one of the particular and preferred embodiments of the present invention.

The present invention also relates a use of a pigment composition of any one of the particular and preferred embodiments of the present invention as a component in an ink, a paint or a coating.

The present invention also relates a method for preparing one or more of an ink, a paint or a coating, comprising employing a pigment composition of any one of the particular and preferred embodiments of the present invention as a component.

A dissolver is a disk stirrer used primarily in the paint and coatings industry, chemical industry and plastics industry for dispersion. Pigment powder is dispersed in a binder system, whereby the dissolver has the function of breaking up agglomerates of primary particles.

The pigment composition of the present invention corresponds to Pigment Brown 29.

The present invention is further illustrated by the following set of embodiments and combinations of embodiments resulting from the dependencies and back-references as indicated. In particular, it is noted that in each instance where a range of embodiments is mentioned, for example in the context of a term such as “The pigment composition of any one of embodiments 1 to 4”, every embodiment in this range is meant to be explicitly disclosed for the skilled person, i.e. the wording of this term is to be understood by the skilled person as being synonymous to “The pigment composition of any one of embodiments 1, 2, 3 and 4”. Further, it is explicitly noted that the following set of embodiments represents a suitably structured part of the general description directed to preferred aspects of the present invention, and, thus, suitably supports, but does not represent the claims of the present invention.
1. A pigment composition comprising a mixed oxide of Fe(III) and Cr(III), wherein the pigment composition has a lightness value in the range of from 5 to 25, and wherein the mixed oxide of Fe(III) and Cr(III):
   is according to a chemical formula (Cr,Fe)₂O₃,
   has a hematite structure,
   has a Dv(100) value in the range of from 3 to 9 μm, and
   has a ratio of Fe(III):Cr(III) in the range of from 74:26 to 58:42.
2. The pigment composition of embodiment 1, wherein the mixed oxide has a Dv(100) value in the range of from 5 to 8 μm, preferably in the range of from 5.5 to 7.5 μm, more preferably in the range of from 6 to 7 μm.
3. The pigment composition of embodiment 1 or 2, wherein the mixed oxide has a ratio of Fe(III):Cr(III) in the range of from 70:30 to 58:42, preferably the mixed oxide has a ratio of Fe(III):Cr(III) of 67:33.
4. The pigment composition of any one of embodiments 1 to 3, wherein the pigment composition has a lightness value in the range of from 3 to 28, preferably in the range of from 4 to 26, more preferably in the range of from 5 to 24.
5. The pigment composition of any one of embodiments 1 to 4, preferably of embodiment 1 or 4, wherein the lightness value is determined in a melamine-based solvent borne binder system, in a water-based binder system or in a two-component polyurethane solvent borne binder system.
6. The pigment composition of any one of embodiments 1 to 5, wherein the pigment composition has a color strength (CS):
   in the range of from 90 to 120, preferably in the range of from 95 to 115, more preferably in the range of from 100 to 110 in a water-based binder system; or
   in the range of from 105 to 155, preferably in the range of from 115 to 145, more preferably in the range of from 125 to 135 in a melamine-based solvent borne binder system; or
   in the range of from 100 to 130, preferably in the range of from 105 to 125, more preferably in the range of from 110 to 120 in a two-component polyurethane solvent borne binder system.
7. The pigment composition of any one of embodiments 1 to 6, wherein the pigment composition has a fineness of grind (FOG):
   in the range of from 5-25 μm, preferably in the range of from 8-20 μm, more preferably in the range of from 11-15 μm in a water-based binder system; or
   in the range of from 5 to 20 μm, preferably in the range of from 6 to 15 μm, more preferably in the range of from 7 to 10 μm in a melamine-based solvent borne binder system; or
   in the range of from 5 to 20 μm, preferably in the range of from 6 to 15 μm, more preferably in the range of from 7 to 10 μm in a two-component polyurethane solvent borne binder system.
8. The pigment composition of any one of embodiments 1 to 7, wherein the pigment composition does not comprise a compound selected from the group consisting of manganese oxide, manganese trioxide, manganite, and a mixture thereof.
9. The pigment composition of any one of embodiments 1 to 7, with the proviso that a pigment composition comprising a compound selected from the group consisting of manganese oxide, manganese trioxide, manganite, and a mixture thereof is excluded.
10. The pigment composition of any one of embodiments 1 to 9, wherein from 90 to 100 weight-%, preferably from 95 to 100 weight-%, more preferably from 98 to 100 weight-%, more preferably from 99 to 100 weight-% of the pigment composition comprises a mixed oxide of Fe(III) and Cr(III).
11. The pigment composition of any one of embodiments 1 to 10, wherein the pigment composition further comprises a grinding aid, preferably the grinding aid is selected from the group consisting of an oxide of silicon, an alkaline earth metal oxide, an alkaline earth metal carbonate and a mixture thereof, more preferably the grinding aid comprises an alkaline earth metal carbonate, preferably the alkaline earth metal carbonate is selected from the group consisting of magnesium carbonate, calcium carbonate, and a mixture thereof, more preferably the alkaline earth metal carbonate comprises, more preferably is calcium carbonate.
12. The pigment composition of embodiment 11, wherein from 0.1 to 8 weight-%, preferably from 0.2 to 6 weight-%, more preferably from 0.25 to 4 weight-%, more preferably from 0.5 to 2 weight-% of the pigment composition comprises the grinding aid, based on 100 weight-% of the pigment composition.
13. A process for preparing a pigment composition, preferably a pigment composition according to any one of embodiments 1 to 12, the process comprising:
   (i) providing a Cr(III) source and a Fe(III) source at a Fe(III):Cr(III) ratio in the range of from 74:26 to 58:42;
   (ii) calcining the Cr(III) source and the Fe(III) source in a rotary device at a temperature in the range of from 500 to 1300° C. and at a rotary speed in the range of from 0.2 to 10 rpm, and obtaining a calcined mixture;
   (iii) providing the calcined mixture and optionally a grinding aid;
   (iv) dry milling the calcined mixture and the optional grinding aid in a jet mill at a pressure in the range of from 0.5 to 5 bar and at a classifier wheel speed in the range of from 3000 to 7000 rpm;
   (v) obtaining a pigment composition comprising a mixed oxide of Fe(III) and Cr(III), wherein the pigment composition has a lightness value in the range of from 5 to 25.
14. The process of embodiment 13, wherein prior to (iv), the process further comprises
   (iii.1) grinding the provided calcined mixture and the optional grinding aid.
15. The process of embodiment 13 or 14, wherein in (i), the Cr(III) source and the Fe(III) source is provided at a Fe(III):Cr(III) ratio in the range of from 70:30 to 58:42, preferably the Cr(III) source and the Fe(III) source are provided at a Fe(III):Cr(III) ratio of 67:33.
16. The process of any one of embodiments 13 to 15, wherein the Fe(III) source is selected from the group consisting of iron oxide, iron hydroxide, iron oxalate, iron carbonate, iron sulfate, iron chloride, iron bromide, iron iodide, iron nitrate, iron thiocyanide, iron cyanide and a mixture thereof, preferably from the group consisting of iron oxide, iron hydroxide and a mixture thereof, more preferably the iron (III) source comprises, more preferably is iron hydroxide.
17. The process of any one of embodiments 13 to 16, wherein the Cr(III) source is selected from the group consisting of chromium oxide, chromium hydroxide, chromium oxalate, chromium carbonate, chromium sulfate, chromium chloride, chromium bromide, chromium iodide, chromium nitrate, chromic acid, chromium chromate, chromium thiocyanide, chromium cyanide and a mixture thereof, preferably from the group consisting of chromium oxide, chromium hydroxide and a mixture thereof, more preferably the Cr(III) source comprises, more preferably is chromium oxide.
18. The process of any one of embodiments 13 to 17, wherein in (ii), from 0.1 to 8 weight-%, preferably from 0.2 to 6 weight-%, more preferably from 0.25 to 4 weight-%, more preferably from 0.5 to 2 weight-% of the grinding aid, based on 100 weight-% of the calcined mixture, is added.
19. The process of any one of embodiments 13 to 18, wherein in the grinding aid is selected from the group consisting of a fumed silica, an alkaline earth metal oxide, an alkaline earth metal carbonate and a mixture thereof, more preferably the grinding aid comprises an alkaline earth metal carbonate, preferably the alkaline earth metal carbonate is selected from the group consisting of magnesium carbonate, calcium carbonate, and a mixture thereof, more preferably the alkaline earth metal carbonate comprises, more preferably is calcium carbonate.
20. The process of any one of embodiments 13 to 19, wherein in (ii), the Cr(III) source and the Fe(III) source is calcined at a temperature in the range of from 500 to 1300° C., preferably in the range of from 550 to 1250, more preferably in the range of from 610 to 1170° C.
21. The process of any one of embodiments 13 to 20, wherein in (ii), the rotary speed is in the range of from 1 to 5 rpm.
22. The process of any one of embodiments 13 to 21, wherein in (iv), the jet mill is a fluidized bed counterjet mill.
23. The process of any one of embodiments 13 to 22, wherein in (iv), the dry milling is at a classifier wheel speed in the range of from 4500 to 6000 rpm.
24. The process of any one of embodiments 13 to 23, wherein in (v), the pigment composition has a lightness value in the range of from 3 to 28, preferably in the range of from 4 to 26, more preferably in the range of from 5 to 24.
25. The process of any one of embodiments 13 to 24, preferably of embodiment 13 or 24, wherein in (v), the lightness value is determined in a melamine-based solvent borne binder system, in a water-based binder system or in a two-component polyurethane solvent borne binder system.
26. The process of any one of embodiments 13 to 25, wherein ultrasonic is not used.
27. The process of any one of embodiments 13 to 26, with the proviso that ultrasonic is excluded.
28. A pigment composition, obtainable or obtained by a process according to any one of embodiments 1 to 12.
29. An ink, a paint or a coating, comprising or consisting of a pigment composition according to any one of embodiments 1 to 12 and 28.
30. Use of a pigment composition according to any one of embodiments 1 to 12 and 28 as a component in an ink, a paint or a coating.
31. A method for preparing one or more of an ink, a paint or a coating, comprising employing a pigment composition according to any one of embodiments 1 to 12 and 28 as a component.

The present invention has been described in detail, including the preferred embodiments thereof. However, it will be appreciated that those skilled in the art, upon consideration of the present disclosure, may make modifications and/or improvements on this invention that fall within the scope and spirit of the invention.

### EXAMPLES

The invention is further described by the following non-limiting examples, which further illustrate the invention, and are not intended, nor should they be interpreted to, limit the scope of the invention.

### Test Methods

### Method for Determining the Particle Size Dv(100) and Dv(50)

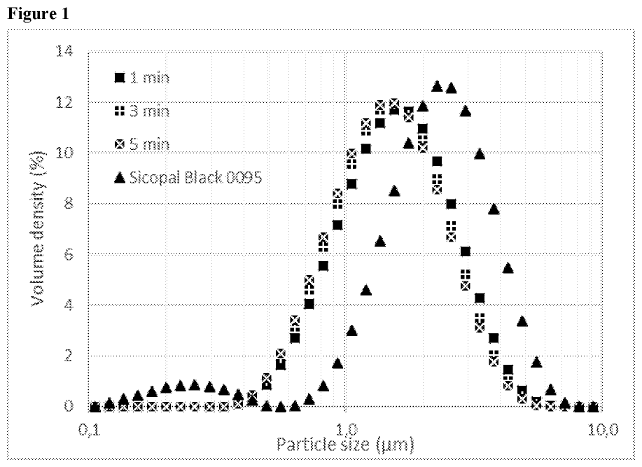

For the determination of particle size the dynamic light scattering method is utilized. A Malvern Mastersizer 3000 equipped with the Hydro MV automatic wet dispersion unit is used. The stirrer is set to 2000 rpm. Then, the pigment is added with 5 mL of a 5% sodium pyrophosphate solution as a dispersion aid. The pigment is added until a 20% shading of the laser light is achieved. No ultrasonic is applied before or during the measurement. The Mastersizer uses Fraunhofer diffraction with additional correction for Mie scattering on small particles to determine the particle sizes. The Dv(100) is defined as the biggest particle measured. The value is obtained by taking the μm channels where particles are still detected by the analyzing device (see FIG. 1). Since measuring the fineness of grind also determines the biggest particle in a coating system, determining the Dv(100) of a Pigment Brown 29 in water is a well-known method to estimate the fineness of grind in many coating systems. The Dv(100) should be less than 10 μm to achieve a fineness of grind of ≤15 μm in a coating system. The Dv(50) value is determined according to the same method as described for the Dv(100) value.

### Method for Determining the Fineness of Grind (FOG)

For the determination of the fineness of grind, a 50 μm grind gauge (DIN EN ISO 1524:2013-06) is utilized. The coating system in which the final pigment was dispersed using a dissolver or shaking machine is applied onto the gauge. Then, the coating is drawn down with a flat edge along the grooves. The depth at which coarse particles or agglomerates become visible on the surface of the coating system as pinholes or scratches is read off from the scale. This value represents the fineness of grind.

### Method for Determining Viscosity

The viscosity is determined according to DIN 53019-1:2008-09 with a MCR 302 rheometer equipped with a 50 mm cone plate with a steep of 2° and a measuring gap of 0.21 mm. The measuring temperature is 23° C.

The fast-dispersing pigment of the present invention was tested in different binder test systems to evaluate its application:

### Melamine-Based Solvent Borne Binder Test System (Binder Test System 1)

To evaluate the fast-dispersing pigment, a melamine-based solvent borne binder test system was used. This system is a combination of a thermosetting hydroxylated acrylic resin, an OH functional hyperbranched polyester and melamine formaldehyde resin. The ratio of pigment:binder for Binder System 1 is 50:50. The viscosity is adjusted with a 7:3 mixture of xylol and butoxy propanol to a viscosity of about 0.59 Pas at a shear rate of 100 s⁻¹. Dispersion is achieved using the dissolver dispersion process.

### Two-Component Polyurethane Solvent Borne Binder Test System (Binder Test System 2)

To evaluate the fast-dispersing pigment a two-component polyurethane solvent borne binder test system was used. This system consists of a hydroxy functional acrylic resin for cross-linking with poly isocyanates. The ratio of pigment:binder for Binder System 2 is 50:50. Viscosity is adjusted with 2:1 mixture of xylol and methiopropamine to a viscosity of about 10.46 Pa's at a shear rate of 100 s⁻¹. As a curing agent, an aliphatic poly isocyanate is used. Dispersion is achieved using the dissolver dispersion process.

### Water-Based Binder Test System (Binder Test System 3)

To evaluate the fast-dispersing pigment a water-based binder test system was used. This system consists of polyethylene glycol and water. The ratio of pigment:binder for Binder System 3 is 70:30. Viscosity is adjusted with a mixture of polyurethane and water to a viscosity of about 0.05 Pa's at a shear rate of 100 s⁻¹. Dispersion is achieved using the dissolver dispersion process.

### Polyvinylidene Fluoride (PVDF) Resin-Based Binder Test System (Binder Test System 4)

To evaluate the fast-dispersing pigment a PVDF resin-based binder test system was used.

The ratio of pigment:binder for Binder System 4 is 50:50. The ratio of PVDF:acrylate is adjusted to 70:30 to reach a viscosity of 20.49 Pa's at a shear rate of 100 s⁻¹. Dispersion is achieved using the dissolver dispersion process.

### Method for Dissolver Dispersion

To prepare a coating system containing the fast-dispersing pigment or a commercially available pigment, the pigment is dispersed in the binder test systems 1-4 using a Dispermat CA-40 by Getzmann equipped with a double-toothed disc. The pigment is dispersed for various intervals. The coating is then used to prepare a mass tone panel as well as a white reduction panel.

### Preparation of White Reduction

A white reduction is prepared by combining a white lacquer with the dispersed pigment coating. Beforehand the pigment preparation can be diluted with the respective binder system to enhance processability. The ratio of white lacquer:pigment preparation is 5:1 and, for the binder test system 4, 4:1. For the white lacquer, TiO₂ is dispersed in a sealable container for one hour in the respective binder system using a dispersion media, e.g., glass beads with a diameter of 3 mm, and a shaker machine.

### Preparation of Full Shade and White Reduction Panel

The dispersed pigment coatings as well as the white reductions are used to prepare a drawn down on a contrast board using a film applicator. The film applicator is equipped with a 50 μm spiral applicator when preparing the full shade panel and with a 150 μm spiral applicator when preparing the white reduction panel. The applicator is moved at a speed of 12.5 mm/s. The drawdowns are cured at room or elevated temperature. When the draw down is not opaque the procedure is repeated.

### Evaluation of the Lightness Value (L)

The term lightness value (L) used herein means the lightness in the L*C*H color space (also referred to as CIELAB) specified by the Commission Internationale de l'Eclairage. Using the masstone panels, colorimetric evaluation is carried out according to the spectral method (ISO 18314-1 (2015)) with d/8° or 8°/d geometry with the specular component included and subsequent computed 4% specular component excluded. The lightness value is determined according to ISO 11664-4 (2008) for light source D65 and 10° standard observer.

### Evaluation of the Relative Color Strength (CS)

Using white reduction panels, the CS is measured in accordance with ISO 18314-2 (2015) by iterative matching of the color depth. The relative CS is evaluated against the commercially available Sicopal Black 0095 after a 60 min shaker dispersion for all 4 binder test systems. For the shaker dispersion, the binder system and the pigment are combined in a sealable container; the pigmentation level is set to 20%; dispersion media (e.g., glass beads with a diameter of 3 mm) are added in the weight ratio 1:1.5 pigment coating:dispersion media and the container is loaded into the shaking machine. The coating is then used to prepare a white reduction panel.

### Example 1: Inventive Pigment

657 kg Cr₂O₃ as well as 1500 kg FeOOH are mixed and heated in a rotary kiln at 610-1170° C. Then 1 weight-% of fumed silica based on 100 weight-% of the obtained (Fe,Cr)₂O₃ is added as milling aid. Subsequently, the pigment is dry milled on a AFG400 jet mill by Hosokawa Alpine with 2.6 bar air pressure and a classifier speed of 5200 rpm. The Dv(100) value amounts to 6 μm. The obtained inventive pigment is then tested in all binder test systems compared to commercially available brown pigments Pigment Brown 29 (Sicopal Black 0095, BASF, purchased in 2022, Comparative Example 1), Dynamix Black 30C941 (Shepherd, purchased in 2023, Comparative Example 2) and Dynamix Black 30C940 (Shepherd, purchased in 2023, Comparative Example 3).

### Example 2: Inventive Pigment

506 kg Cr₂O₃ as well as 1155 kg FeOOH are mixed and heated in a rotary kiln at 610-1170° C. Then 1 weight-% of fumed silica as well as 0.75 weight-% of calcium carbonate based on 100 weight-% of the obtained (Fe,Cr)₂O₃ is added as milling aid. Subsequently, the pigment is dry milled on a AFG400 jet mill by Hosokawa Alpine with 2.5 bar air pressure and a classifier speed of 5500 rpm. The Dv(100) value amounts to 6 μm. The obtained inventive pigment is then tested in all binder test systems compared to commercially available brown pigments Pigment Brown 29 (Sicopal Black 0095, BASF, purchased in 2022, Comparative Example 1), Dynamix Black 30C941 (Shepherd, purchased in 2023, Comparative Example 2) and Dynamix Black 30C940 (Shepherd, purchased in 2023, Comparative Example 3).

TABLE 1
Inventive Example 1 vs. Comparative Examples 1 to 3 in
Binder System 1 using a dissolver dispersion process

| | Dispersion | Lightness | Color | FOG | DI Value |
|---|---|---|---|---|---|
| Example | (min) | value | strength | (μm) | (1/μm³) |
| Sicopal Black 0095 | 10 | 11.5 | 112 | 30 | 1.2 |
| (Comp. Ex. 1) | 20 | 11.8 | 119 | 25 | 1.8 |
| | 30 | 11.7 | 124 | 25 | 1.8 |
| Inv. Ex. 1 | 10 | 12.1 | 126 | 18 | 5.4 |
| | 20 | 12.1 | 131 | 12 | 12.5 |
| | 30 | 12.2 | 135 | 10 | 18.4 |
| Dynamix | 10 | 12.1 | 99 | 10 | 14.9 |
| Black 30C941 | 20 | 12.1 | 103 | <10 | >19.1 |
| (Comp. Ex. 2) | 30 | 12.3 | 106 | <10 | >19.3 |
| Dynamix | 10 | 11.8 | 114 | 10 | 17.6 |
| Black 30C940 | 20 | 11.9 | 119 | <10 | >22.4 |
| (Comp. Ex. 3) | 30 | 12.0 | 121 | <10 | >22.6 |

While the commercially available pigment Sicopal Black 0095 cannot reach a fineness of grind ≤15 μm in Binder System 1, the inventive pigment reaches this value after 20 min. The commercially available pigments Dynamix Black 30C941 and 30C940 reach that value already after 10 min, however, the inventive pigment exhibits a rigorous increase of color strength already after 10 min of dispersion.

TABLE 2
Inventive Example 1 vs. Comparative Examples 1 to 3 in
Binder System 2 using a dissolver dispersion process

| | Dispersion | Lightness | Color | FOG | DI Value |
|---|---|---|---|---|---|
| Example | (min) | value | strength | (μm) | (1/μm³) |
| Sicopal Black 0095 | 30 | 11.4 | 112 | 17 | 3.7 |
| (Comp. Ex. 1) | | | | | |
| Inv. Example 1 | 30 | 10.2 | 117 | <10 | >23.6 |
| Dynamix | 30 | 12.1 | 91 | <10 | >16.9 |
| Black 30C941 | | | | | |
| (Comp. Ex. 2) | | | | | |
| Dynamix | 30 | 11.4 | 102 | <10 | >20.1 |
| Black 30C940 | | | | | |
| (Comp. Ex. 3) | | | | | |

Table 2 shows the measured values after the pigments were dispersed in binder test system 2 for 30 min. When using a dissolver as a dispersion tool the inventive pigment exhibits a higher color strength compared to commercially available pigments as well as a lower fineness of grind than the Sicopal Black 0095.

TABLE 3
Inventive Example 1 vs. Comparative Examples 1 to 3 in
Binder System 3 using a dissolver dispersion process

| | Dispersion | Lightness | Color | FOG | DI Value |
|---|---|---|---|---|---|
| Example | (min) | value | strength | (μm) | (1/μm³) |
| Sicopal Black 0095 | 30 | 5.6 | 104 | 30 | 2.2 |
| (Comp. Ex. 1) | | | | | |
| Inv. Example 1 | 30 | 5.8 | 108 | 12 | 1.6 |
| Dynamix | 30 | 5.8 | 79 | 10 | 24.8 |
| Black 30C941 | | | | | |
| (Comp. Ex. 2) | | | | | |
| Dynamix | 30 | 4.9 | 88 | 13 | 19.3 |
| Black 30C940 | | | | | |
| (Comp. Ex. 3) | | | | | |

Table 3 shows the measured values after the pigments were dispersed in binder test system 3 using a dissolver after several dispersion times. While showing similar color strength as well as lightness value, the inventive pigment reaches a fineness of grind value of 15 μm after only 20 min, while the comparative pigment only reaches a fineness of grind value of 25 μm, even after 60 min.

TABLE 4
Inventive Example 1 vs. Comparative Example 1 in Binder
System 4 using a dissolver dispersion process

| | Dispersion | Lightness | Color | FOG | DI Value |
|---|---|---|---|---|---|
| Example | (min) | value | strength | (μm) | (1/μm³) |
| Sicopal Black 0095 | 30 | 10.1 | 115 | 25 | 3.0 |
| (Comp. Ex. 1) | | | | | |
| Inv. Example 1 | 30 | 9.8 | 118 | <5 | 80.3 |

Table 4 shows the inventive and comparative dispersions in binder test system 4. Similar to the other test binder systems, the inventive pigment shows a superior fineness of grind value when dispersed in a dissolver system compared to the commercially available pigment.

### CITED LITERATURE

CN112194928A
JP2019183042A
U.S. Pat. No. 10,844,184B2
CN104559439A
U.S. Pat. No. 9,926,415B2
U.S. Pat. No. 9,169,399B2
U.S. Pat. No. 8,270,064B2
US20110219984A1
JP5285307B2
U.S. Pat. No. 8,691,332B2
JP4783549B2
U.S. Pat. No. 6,758,894B1
KR20020072687A
JP2000104006A
JP11209558
JP05285307
U.S. Pat. No. 4,388,118A
U.S. Pat. No. 4,426,465A
U.S. Pat. No. 2,811,463A

1. A dry Pigment Brown 29 pigment composition, comprising chromium and an iron-based oxide with a hematite structure, wherein the pigment composition is dry milled on a jet mill, hammer mill, dry ball mill or pen mill for reducing the particle size distribution as well as the fineness of the grind,
wherein the dry-milled pigment exhibits a Dispersibility Index (DI) increase of >100%, vs. the commercially available Pigment Brown 29, Sicopal Black 0095 from BASF as a comparable example, after being subjected to 30 minutes of dispersion using a dissolver dispersion process in a melamine-based solvent borne binder system or a water-based binder system, and wherein DI is determined according to Equation 1:
$$DI = \frac{{10}^{3} \cdot Color Strength}{{FOG}^{2} ( μm ) \cdot Lightness Value \cdot Dv ( 100 ) ( μm )} . \qquad ( Equation 1 )$$
and wherein
the color strength in the melamine-based solvent borne binder system is in the range from 105 to 155;
the FOG in the melamine-based solvent borne binder system is in the range of from 5 to 20 μm;
the lightness value in the melamine-based solvent borne binder system is in the range of from 6 to 25;
and wherein
the color strength in the water-based binder system is in the range of from 90 to 120;
the FOG in the water-based binder system is in the range of from 5 to 25 μm;
the lightness value in the water-based binder system is in the range of from 3 to 12,
and wherein for the comparative example when a melamine-based solvent borne binder test system is used which is a combination of a thermosetting hydroxylated acrylic resin, an OH functional hyperbranched polyester and melamine formaldehyde resin with a ratio of pigment binder being 50:50, the viscosity being adjusted with a 7:3 mixture of xylol and butoxy propanol to a viscosity of about 0.59 Pa·s at a shear rate of 100 s⁻¹, the lightness value is 11.7, the color strength is 124, the FOG is 25 μm and the DI value is 1.8/μm³,
and wherein for the comparative example when a water-based test system is used which consists of polyethylene glycol and water with a ratio of pigment binder being 70:30, the viscosity being adjusted with a mixture of polyurethane and water to a viscosity of about 0.05 Pa·s at a shear rate of 100 s⁻¹, the lightness value is 5.6, the color strength is 104, the FOG is 30 μm and the DI value is 1.8/μm³.

2. The pigment composition of claim 1, wherein the color strength in the melamine-based solvent borne binder system is in the range of from 115 to 145.

3. The pigment composition claim 1, wherein the FOG in the melamine-based solvent borne binder system is in the range of from 6 to 15 μm.

4. The pigment composition of claim 1, wherein the lightness value in the melamine-based solvent borne binder system is in the range of from 7 to 18.

5. The pigment composition of claim 1, wherein the color strength in the water-based binder system is in the range of from 95 to 115.

6. The pigment composition claim 1, wherein the FOG in the water-based binder system is in the range of from 8 to 20 gm.

7. The pigment composition of claim 1, wherein the lightness value in the water-based binder system is in the range of from 4 to 10.

8. A dry milled Pigment Brown 29 pigment composition, comprising chromium and an iron-based oxide with a hematite structure, wherein the pigment composition is dry milled on a jet mill, hammer mill, dry ball mill or pen mill for reducing the particle size distribution as well as the fineness of the grind,
wherein the dry-milled pigment exhibits a Dispersibility Index (DI) increase of >500%, vs. a commercially available Pigment Brown 29, Sicopal Black 0095 from BASF as a comparable example, after being subjected to 30 minutes of dispersion using a dissolver dispersion process in a two-component polyurethane solvent borne system, and wherein DI is determined according to Equation 1:
$$DI = \frac{{10}^{3} \cdot Color Strength}{{FOG}^{2} ( μm ) \cdot Lightness Value \cdot Dv ( 100 ) ( μm )} . \qquad ( Equation 1 )$$
and wherein
the color strength is in the range from 100 to 130;
the FOG is in the range of from 5 to 20 μm;
the lightness value is in the range of from 6 to 25;
and wherein for the comparative example when a two-component polyurethane solvent borne binder system is used consisting of a hydroxy functional acrylic resin for cross-linking with polyisocyanates, the ratio of pigment:binder being 50:50, the viscosity being adjusted with a 2:1 mixture of xylol and methiopropamine to a viscosity of about 10.46 Pa·s at a shear rate of 100 s⁻¹, and, as a curing agent, an aliphatic polyisocyanate being used, the lightness value is 11.4, the color strength is 112, the FOG is 17 μm and the DI value is 3.7/μm³.

9. The pigment composition of claim 8, wherein the color strength is in the range of from 105 to 125.

10. The pigment composition claim 8, wherein the FOG is in the range of from 6 to 15 μm.

11. The pigment composition of claim 8, wherein the lightness value is in the range of from 7 to 18.

12. A dry milled Pigment Brown 29 pigment composition, comprising chromium and an iron-based oxide with a hematite structure, wherein the pigment composition is dry milled on a jet mill, hammer mill, dry ball mill or pen mill for reducing the particle size distribution as well as the fineness of the grind,
wherein the dry-milled pigment exhibits a Dispersibility Index (DI) increase of >1000 vs. a commercially available Pigment Brown 29, Sicopal Black 0095 from BASF as a comparable example, after being subjected to 30 minutes of dispersion using a dissolver dispersion process in a Polyvinylidene fluoride (PVDF) resin-based binder system, wherein DI is determined according to Equation 1:
$$DI = \frac{{10}^{3} \cdot Color Strength}{{FOG}^{2} ( μm ) \cdot Lightness Value \cdot Dv ( 100 ) ( μm )} . \qquad ( Equation 1 )$$
and wherein
the color strength is in the range from 100 to 130;
the FOG is in the range of from 2 to 15 μm;
the lightness value is in the range of from 6 to 25;

13. The pigment composition of claim 12, wherein the color strength is in the range of from 105 to 125.

14. The pigment composition claim 12, wherein the FOG is in the range of from 3 to 10 μm.

15. The pigment composition of claim 12, wherein the lightness value is in the range of from 7 to 18.

16-27. (canceled)

28. An ink, paint or coating composition, comprising the pigment of claim 1.

29-30. (canceled)

31. A process for preparing a Pigment Brown 29 pigment composition of claim 1, comprising a solid-state reaction between a mixture of a chromium source and an iron source, wherein the mixture is calcined at elevated temperatures and then dry milled, and wherein the pigment exhibits a Dispersibility Index (DI) increase of >100%, vs. a comparative example after being subjected to 30 minutes using a dissolver dispersion process, and wherein DI is determined according to Equation 1:
$$DI = \frac{{10}^{3} \cdot Color Strength}{{FOG}^{2} ( μm ) \cdot Lightness Value \cdot Dv ( 100 ) ( μm )} . \qquad ( Equation 1 )$$

32. The process of claim 31, further comprising the step of pre-grinding after being calcined.

33. The process of claim 32, wherein the mixture is calcined at a temperature in the range of from 610 to 1170° C.

34-35. (canceled)

36. The process of claim 33, wherein the chromium source and the iron source are mixed at an iron source:chromium source ratio in the range of from 74:26 to 58:42.

37-49. (canceled)
